(19) United States
(12) Patent Application Publication
(10) Pub. No.: US 2018/0361389 A1
(43) Pub. Date: Dec. 20, 2018

(54) PAPER SHREDDER

(71) Applicant: Stephen Kwok Ki Chan, Hong Kong (CN)

(72) Inventor: Stephen Kwok Ki Chan, Hong Kong (CN)

(21) Appl. No.: 15/625,520

(22) Filed: Jun. 16, 2017

(51) Int. Cl. B02C 18/00; B02C 18/14; B02C 18/22

(52) U.S. Cl. CPC B02C 18/0007; B02C 2018/0038; B02C 18/2216; B02C 18/142

(57) ABSTRACT

A paper shredder includes a housing having an oblong entrance and an oblong exit for paper to be shredded, an electric motor, and a shredding mechanism driven by the electric motor and in a paper feeding path from the entrance to the exit for cutting paper entering the housing via the entrance into smaller paper pieces which exit via the exit. An exit device is attached to the exit for exit of the paper pieces. The exit device extends along the length of the exit for collecting the paper pieces, has an opening for exit of the paper pieces, and includes a moving mechanism for moving the paper pieces to the opening.

The present invention relates to a paper shredder.

### BACKGROUND OF THE INVENTION

Paper shredders are indispensable in an office and are becoming increasingly popular for use at home. Paper shredders tend to be bulky and power demanding, often requiring use of the mains power. With reduction in the size, increasing numbers of relatively more compact paper shredders find their way into the domestic market, which are often DC or battery operated.

Compact paper shredders require emptying all so often as their shredded paper holder has an inherently limited volume, whilst those of a different type are designed for use directly over a trash or wastepaper bin, without an attached holder for collecting the shredded paper. Compact paper shredders of such a different type are often designed for handheld operation.

Handling of compact paper shredders requires care and attention. First, the internal shredding mechanism may be exposed or accessible on the paper exit side, especially when a shredded paper hander has been removed, thereby presenting a risk of injury to the fingers of a user. Second, for those of the handheld type without a shredded paper holder, they have to be placed with care or properly on or over a wastepaper bin, otherwise the shredded paper pieces may be discharged off the bin.

The use of DC and in particular battery power is desirable for use at home because of the freedom to move about and usability at different locations. However, not until the problem of power requirement is solved or at least lessened, size cannot be further reduced or battery operation remains an impractical option.

The invention seeks to mitigate or at least alleviate such problems or shortcomings by providing a new or otherwise improved paper shredder.

### SUMMARY OF THE INVENTION

According to the invention, there is provided a paper shredder comprising a housing having an oblong entrance and an oblong exit for paper to be shredded, an electric motor in the housing, and a shredding mechanism driven by the electric motor and provided in the housing in a paper feeding path from the entrance to the exit for cutting said paper entering the housing via the entrance into smaller paper pieces which are then to exit via the exit. An exit device is attached to the exit for arranging exit of said paper pieces. The exit device extends along the length of the exit for collecting said paper pieces, has an opening for exit of said paper pieces, and includes a moving mechanism for moving said paper pieces to the opening for exit.

Preferably, the shredding mechanism comprises two rows of shredding units mounted for rotation in opposite directions about respective parallel axes, the shredding units of one of the two rows being overlapped with those of the other row in an interlaced manner.

Preferably, the moving mechanism comprises a flow-creating device adapted to create a flow of said paper pieces to the opening.

More preferably, the flow-creating device comprises at least one rotating member for creating a said flow.

Further more preferably, said at least one rotating member extends along at least part of the length of the exit for contact with said paper pieces to move said paper pieces to the opening.

Yet further more preferably, said at least one rotating member has a helical configuration.

In a preferred embodiment, said at least one rotating member comprises a helical blade.

More preferably, the helical blade extends for a plurality of turns around and along a central axis of the flow-creating device.

Further more preferably, the flow-creating device includes a shaft along the central axis, and the helical blade comprises a series of blade sections arranged on and along the shaft to form the helical blade.

Yet further more preferably, the shaft has an outer cross-section, and each of the blade sections has a central hole having an inner cross-section, the outer cross-section and inner cross-section being of complimentary non-circular shapes for angular inter-engagement such that the blade sections are rotatable with the shaft as a one-piece member.

It is preferred that each blade section extends through an angle of less than 360° around the shaft.

It is further preferred that each blade section extends through an angle of about 270° around the shaft.

It is preferred that the blade includes agitating means adapted to agitate said paper pieces, thereby facilitating movement of said paper pieces.

It is further preferred that the blade has an edge of a wavy shape or profile, which constitutes the agitating means.

In a specific construction, said at least one rotating member comprises a metering screw including the helical blade that extends helically along the length of the metering screw.

In a preferred embodiment, the opening is provided at an end of the exit device. More preferably, the exit device includes an oblong casing having opposite ends, with one end open to provide the opening and the opposite end at which the moving mechanism is driven.

Advantageously, the moving mechanism of the exit device is driven by the electric motor.

In a preferred embodiment, the exit device is detachable from and re-attachable to the exit.

More preferably, the paper shredder includes a control circuit for operation to control supply of electrical power to the electric motor, the control circuit including a detector for detecting the exit device upon attachment of the exit device to the exit, thereby enabling the operation of the control circuit.

Further more preferably, the detector comprises a normally-open electrical switch arranged to be closed upon attachment of the exit device to the exit.

In a preferred embodiment, the entrance and exit comprise respective slots each having an open end on an outer lateral side of the paper feeding path, such that paper wider than the paper feeding path may in part be fed through the paper shredder for shredding only that part of said paper.

Preferably, the housing has a forward-pointing main part which has a bifurcate configuration to form the slots, each having an open end, of the entrance and exit.

Preferably, a section of the slot of the exit includes a deflector or deflecting surface to one side of the exit device, the section positioned beyond the shredding mechanism on the outer lateral side of the paper feeding path, such that an un-shredded part of said paper is deflected to go past the exit device.

More preferably, the exit device includes the deflector or deflecting surface that defines one side of the paper feeding path over the section.

### BRIEF DESCRIPTION OF DRAWINGS

The invention will now be more particularly described, by way of example only, with reference to the accompanying drawings, in which:

FIG. 1 is a bottom perspective view of an embodiment of a paper shredder in accordance with the invention;

FIG. 2 is another bottom perspective view of the paper shredder of FIG. 1, showing its internal components;

FIG. 3 is a bottom perspective view similar to FIG. 2, showing the paper shredder in operation shredding a sheet of paper;

FIG. 4 is a cross-sectional side view of the paper shredder of FIG. 3;

FIG. 5 is a bottom perspective view similar to FIG. 1, showing an exit device attachable to an exit of the paper shredder;

FIG. 6 is a bottom perspective view of the paper shredder of FIG. 5, showing its internal components and the exit device;

FIGS. 7A and 7B are cross-sectional side views of the paper shredder of FIG. 6, showing how the exit device is attached;

FIG. 8 is a bottom perspective view of the exit device of FIG. 5;

FIG. 9 is a top perspective view of the exit device of FIG. 8;

FIG. 10 is a bottom perspective view similar to FIG. 8, showing a rotating member of a moving mechanism separated from the exit device;

FIG. 11 is a cross-sectional side view of the exit device of FIG. 10, showing the rotating member back in the exit device;

FIG. 12 is a side view of the rotating member of FIG. 10;

FIG. 13 is a cross-sectional view of the rotating member of FIG. 12, taken along line XIII-XIII;

FIG. 14 is a perspective view of the rotating member of FIG. 10;

FIG. 15 is an exploded perspective view of the rotating member of FIG. 14;

FIG. 16 is an exploded perspective view of the exit device of FIG. 10; and

FIG. 17 is an enlarged perspective view of one of five blade sections of the rotating member of FIG. 16.

### DETAILED DESCRIPTION OF PREFERRED EMBODIMENT

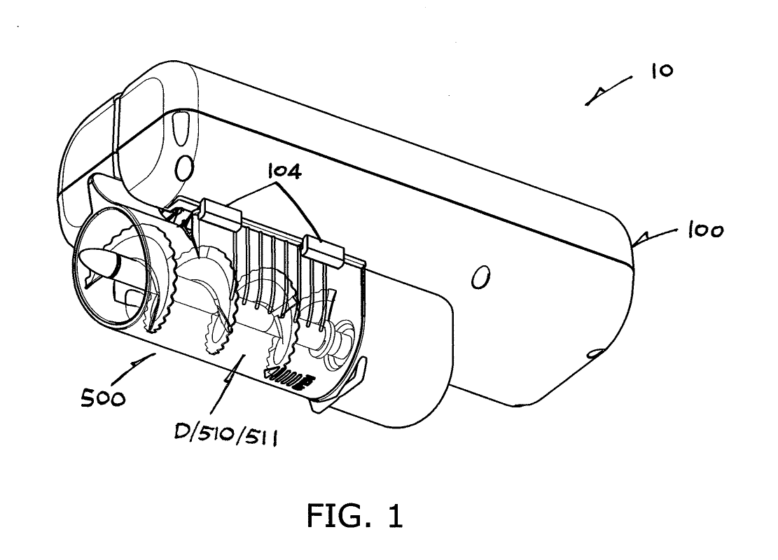

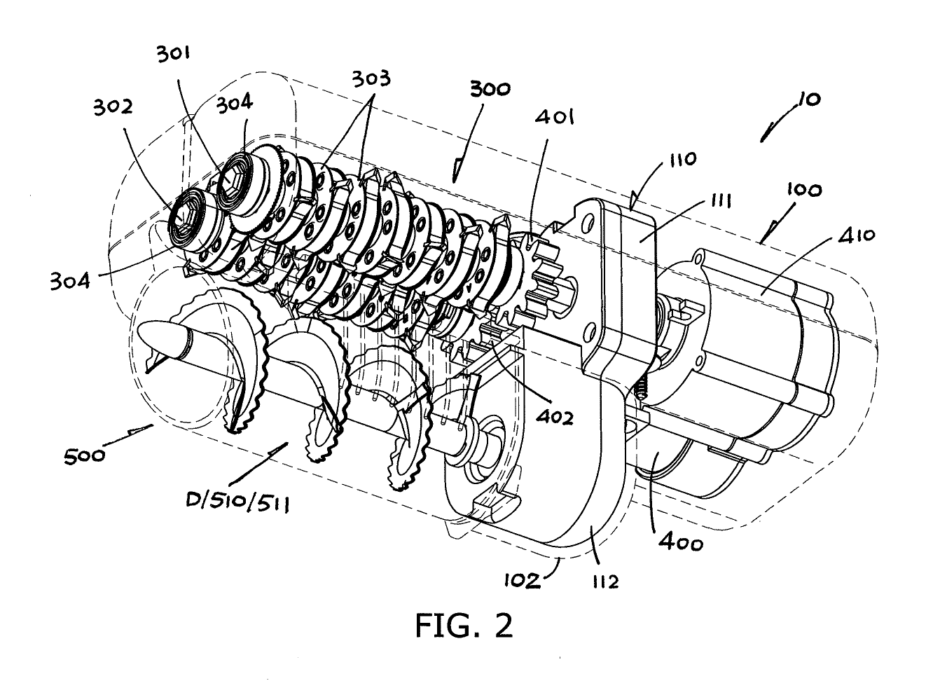

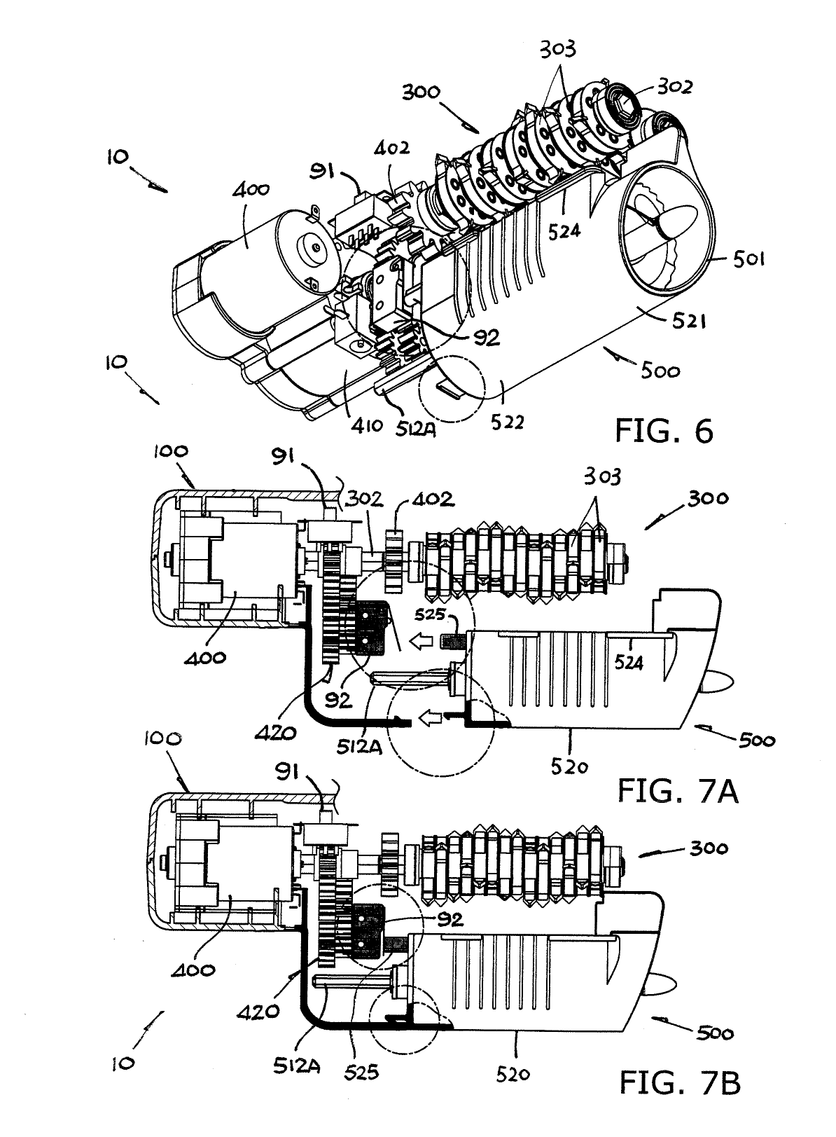

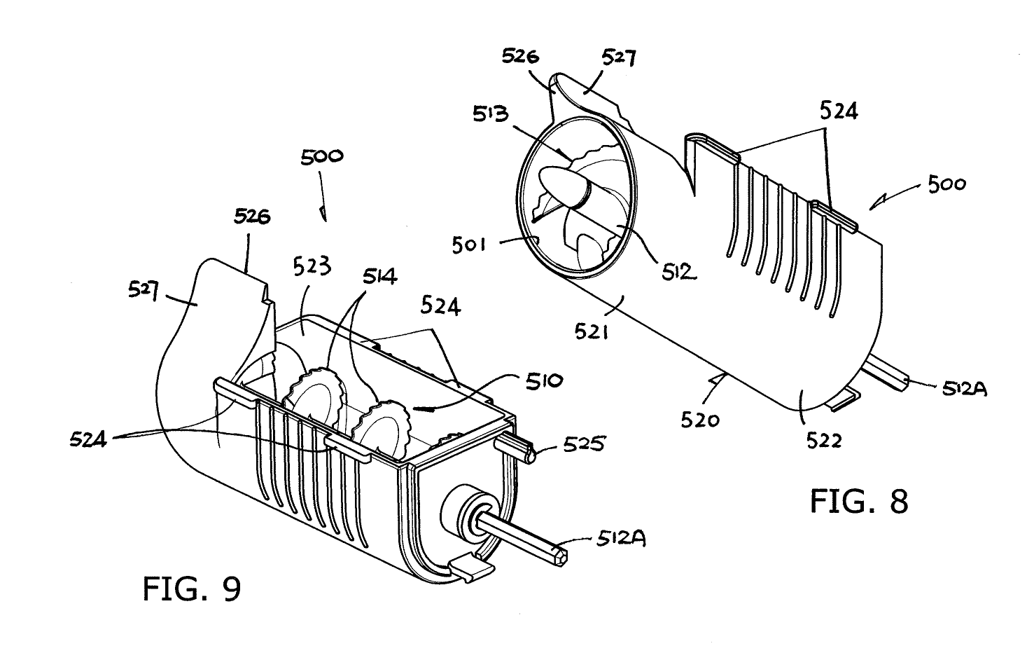

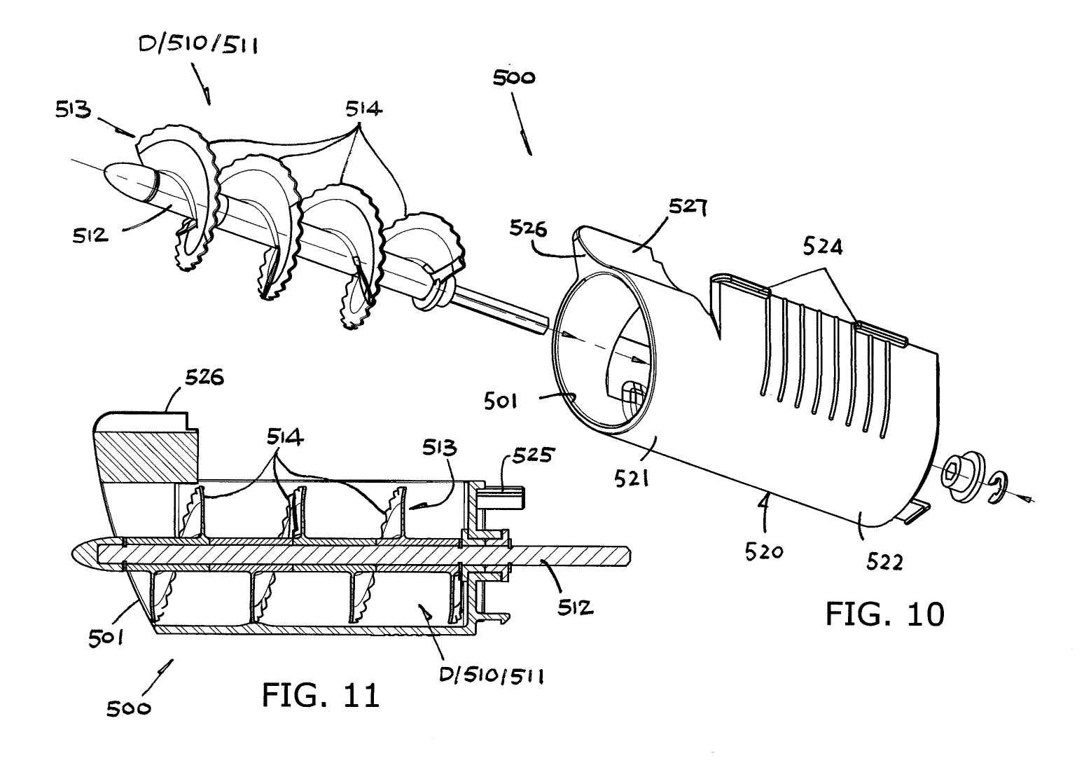

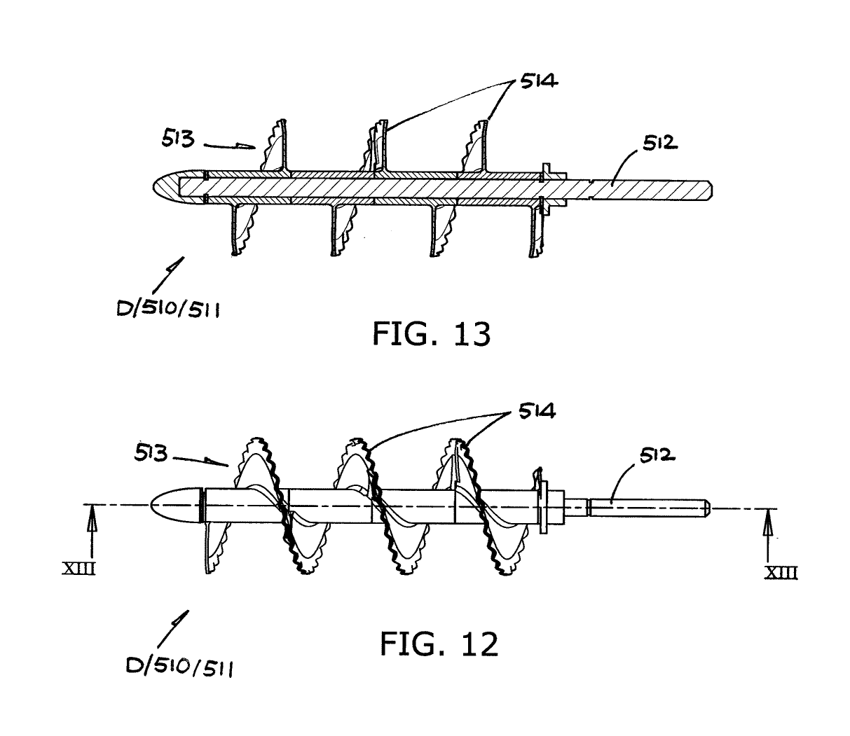

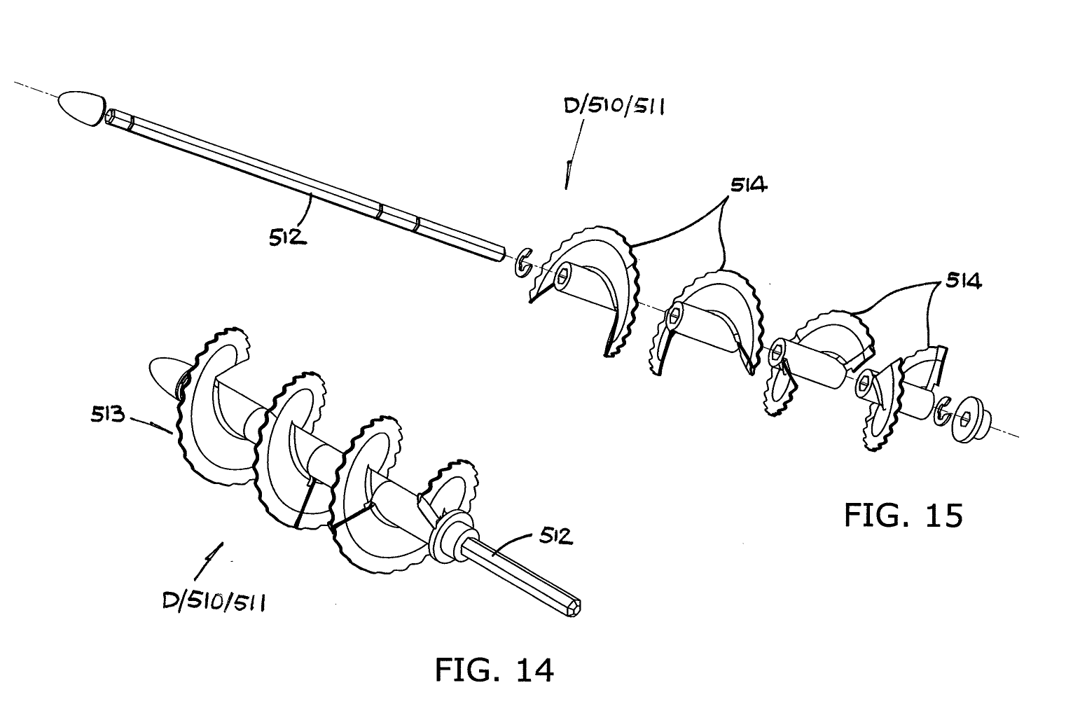

Referring to FIGS. 1 to 17 of the drawings, there is shown a paper shredder 10 embodying the invention, which has a housing 100, an electric motor 400 in the housing 100, a shredding mechanism 300 provided in the housing 100 and driven by the electric motor 400, and an exit device 500 attached to the housing 100. The paper shredder 10 may be a portable or handheld paper shredder or is preferably compact in size such that it can be attached by means of a clamp or bracket onto a wastepaper bin for use above it, with the housing 100 having an oblong shape and extending horizontally.

The housing 100 has a forward-pointing main part which includes an oblong entrance 210 and an oblong exit 220 for sheet material, in the form of for example a paper sheet P, to be shredded. The shredding mechanism 300 is provided in a paper feeding path X from the entrance 210 to the exit 220 for cutting the paper sheet P entering the housing 100 via the entrance 210 into smaller paper pieces S, in the form of for example numerous paper strips of considerably shorter length, which are then to exit via the exit 220 for being discharged. The exit device 500 is attached to the exit 220 for the purpose of arranging exit of the paper pieces S.

The housing 100 is an oblong structure having opposite ends, within which the shredding mechanism 300 and the motor 400 are located respectively, with the exit device 500 attached immediately underneath and in alignment with the shredding mechanism 300. A hollow mount 110 is fixed upright in the housing 100 between the shredding mechanism 300 and the motor 400, for mounting the shredding mechanism 300 and the exit device 500. A cylindrical gearbox 410 is located alongside the motor 400 for reducing the speed of the motor's output drive and hence increasing the torque for driving the shredding mechanism 300.

The shredding mechanism 300 is provided by two rows of shredding units 303 mounted for rotation in opposite directions about respective parallel axes, with the shredding units 303 of one of the two rows being overlapped with those of the other row in an interlaced manner More specifically, the shredding mechanism 300 includes a pair of hexagonal-sectioned shafts 301 and 302 supported for rotation about respective co-parallel horizontal axes, on each of which shafts 301 and 302 a respective row of the shredding units 303 is mounted for rotation by the shaft 301/302.

The shafts 301 and 302 extend co-parallel from the mount 110, with their near ends held by respective bearings in the mount 110 and their distal ends supported by respective bearings 304 in engagement with an opposite 101 wall of the housing 100. A pair of inter-meshing gearwheels 401 and 402 mounted fast at their near ends couples the two shafts 301 and 302 together for simultaneous rotation in opposite directions at the same speed and in turn driving their shredding units 303. The first shaft 301 is in drive engagement with the gearbox 410 via a gear train 420 provided inside the mount 110, for rotation by the motor 400, with the second shaft 302 following to rotate via the gearwheels 401 and 402.

In operation, the shredding mechanism 300 cuts a sheet of paper P or the like, fed through the entrance 210 into the gap between the two rows of shredding units 303, into numerous much shorter paper strips S which leave the exit 220, as they are produced, under the action of gravity.

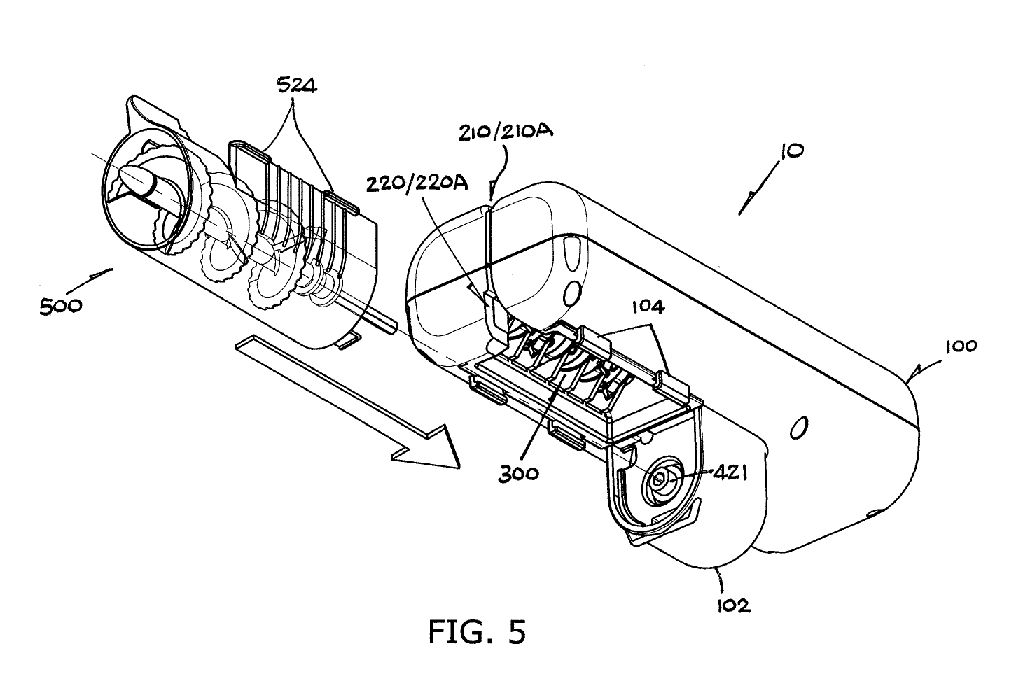

The paper shredder 10 includes a control circuit for operation to control the operation of the paper shredder 10 and in particular the supply of electrical power to the motor 400. The control circuit has an electrical switch in the form of a slide switch 91 on the housing 100, acting as the main switch for manual switching on and off the paper shredder 10. The control circuit includes an auxiliary electrical switch 92 for use as a detector to detect the exit device 500 upon attachment of the exit device 500 to the exit 220 (FIG. 5), thereby enabling the operation of the control circuit. The detector is preferably provided by a normally-open electrical switch 92 which is arranged to be closed upon attachment of the exit device 500 to the exit 220.

The mount 110 has an upper main body 111 for mounting the shredding mechanism 300 and a lower extension 112 for mounting the exit device 500. The housing 100 has a depending bottom part 102 which encases the extension 112 and is open on its front side to permit access of the extension 112 by the exit device 500 for mounting.

The gear train 420 extends internally from the mount's main body 111, where it drives the shredding mechanism 300, to the extension 112, where it rotates a driving socket 421 for driving the exit device 500. With this arrangement, the electric motor 400 drives the shredding mechanism 300 as well as the exit device 500. The socket 421 is oriented to have a horizontal central axis that extends parallel to the shafts 301 and 302 of the shredding mechanism 300.

The housing 100 may include a battery compartment for holding several DC battery cells, of the dry or rechargeable type, for powering the electric motor 400. Alternatively, the control circuit may include a power circuit for connection to an external AC power source to obtain the necessary power.

The exit 220 of the paper shredder 10 is relatively wide to allow unobstructed exit of the shredded paper strips S. Upon attachment to the exit 220 (FIG. 5), the exit device 500 closes or blocks the exit 200, whereby the exit 220 and in particular the shredding units 303 of the shredding mechanism 300 exposed through the exit 220 become inaccessible by the fingers of a user to protect the user from personal injury.

The exit device 500 serves to arrange for the exit of the paper strips S in a smooth and orderly manner and, in particular, to discharge the paper strips S through a relatively smaller or restricted opening, such that the paper strips S can easily be collected or dropped into a trash or wastepaper basket.

The exit device 500 extends along the length of the shredder's exit 220 for collecting or receiving the paper pieces S. It has an opening 501 for exit of the paper pieces S, and includes a moving mechanism 510 for moving the paper pieces S to the opening 501 for exit.

The exit device 500 has an oblong casing or shell 520 of a shell-like shape having opposite front and rear ends 521 and 522 and an open top side 523. The front end 521 is open to provide the opening 501. The moving mechanism 510 is driven at the rear end 522. An axially-extending stud 525 at the rear end 522 serves to close the normally-open switch 92, upon attachment of the exit device 500 to the exit 220 (FIGS. 7A to 7B), to thereby enable the operation of the control circuit and hence the overall paper shredder 10.

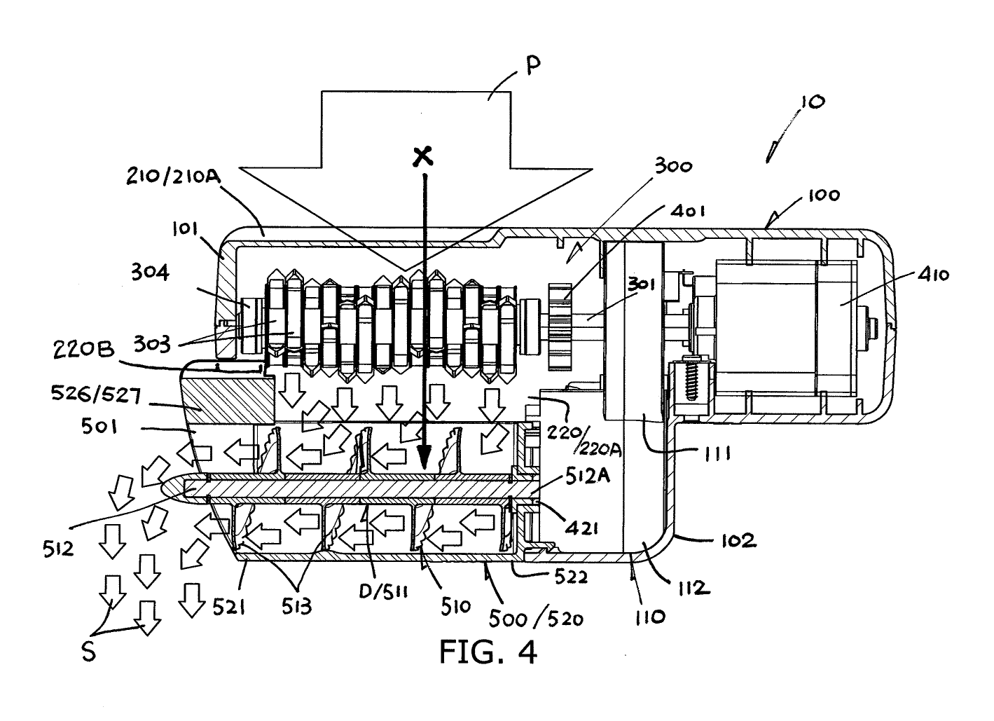

In terms of concept, the moving mechanism 510 comprises a flow-creating device D adapted to create a flow of the paper strips S to the end opening 501 for exit therefrom (FIG. 4). The flow-creating device D comprises at least one rotating member 511 for creating the flow. In general, the rotating member 511 has either one, or both, of a helical configuration and helical blade (513).

In another embodiment though not depicted in the drawings, such a rotating member may take the form of an impeller or fan having a plurality of blades, together in a helical configuration as is inherent for fan blades. Upon rotation, the fan creates an air flow which then carries the paper strips S to the end opening 501 for exit therefrom. To facilitate ditching of the paper strips S, the shell 520 may be modified to turn the end opening 501 spouted directly into a wastepaper basket.

Returning to the described embodiment, the rotating member 511 is an elongate member and extends along at least part of the length of the exit 220, or substantially the entire length of the exit 220 as shown in the drawings, for contact with the paper strips S in order to move the paper strips S to the end opening 501. The helical blade, designated by reference numeral 513, extends for a plurality of turns, e.g. about three and three-quarters (3¾) turns as shown, around and along a central axis of the flow-creating device D. Thus, the rotating member 511 takes the form of a metering screw including the helical blade 513 that extends helically along the length of the metering screw.

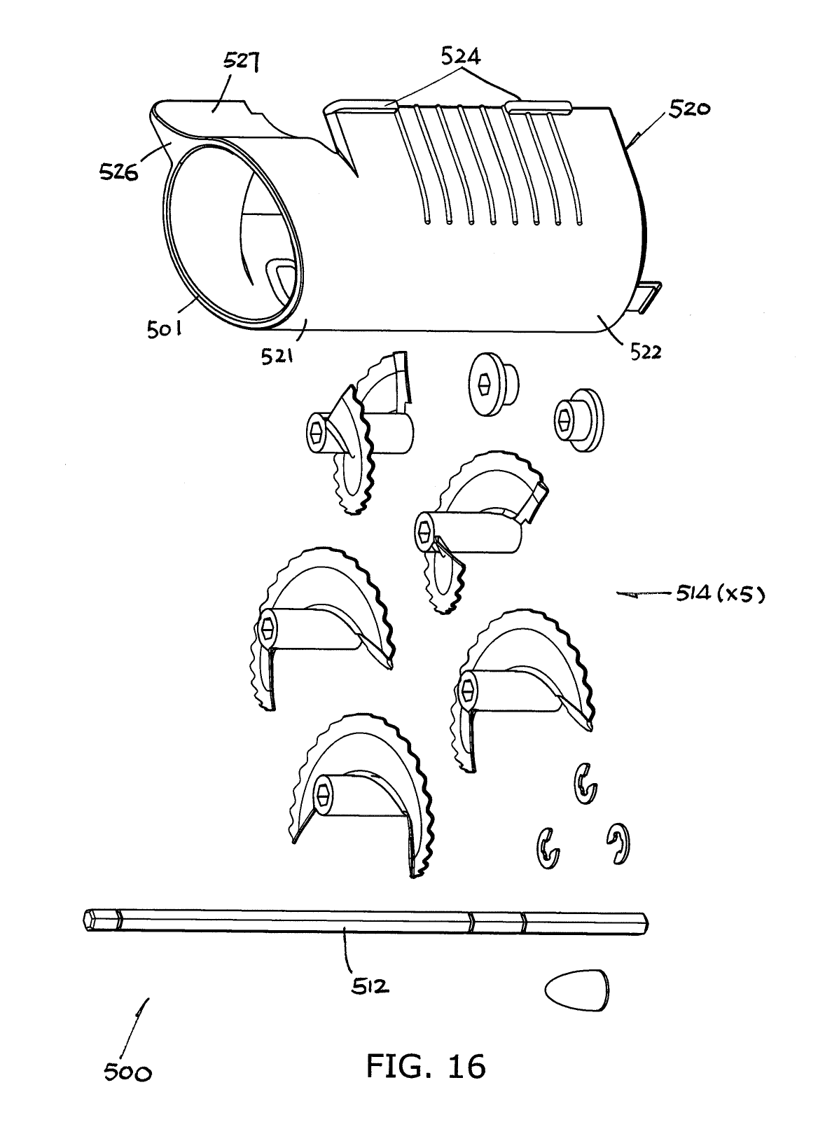

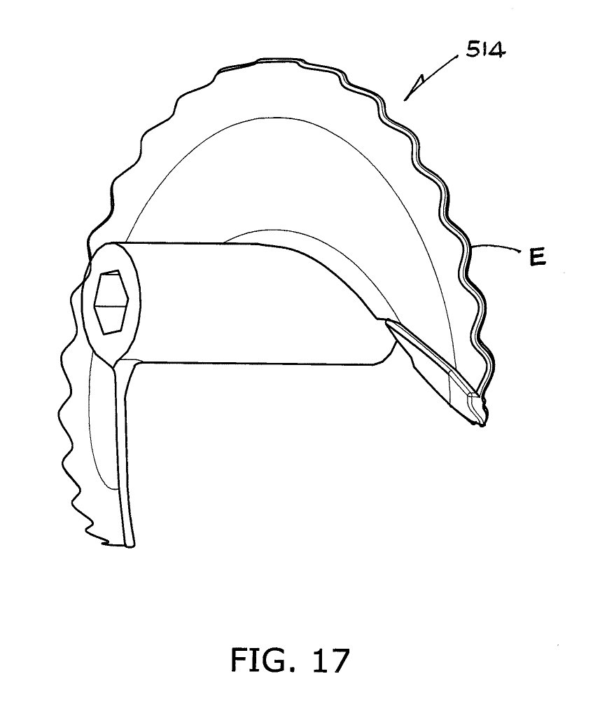

In specific construction, the flow-creating device D includes a shaft 512 extending along the aforesaid central axis. The helical blade 513 comprises a series of adjoining blade sections 514, e.g. five blade sections 514 as shown in FIG. 16, arranged on and along the shaft 512 to form the helical blade 513. The blade sections 514 preferably share an identical construction, each extending through an angle of less than 360° around the shaft 512 or, more specifically, about 270° (i.e. three quarters of a turn) around the shaft 512.

The shaft 512 has an outer cross-section, and each of the blade sections 514 has a central hole having an inner cross-section. Such outer cross-section and inner cross-section are of complimentary non-circular shapes, e.g. hexagonal as shown in FIG. 16, for angular inter-engagement such that the blade sections 514 are rotatable with the shaft 512 as a one-piece member.

The rotating member 511 functions as a metering screw to deliver the paper strips S, by creating a flow of the paper strips S, along its length to reach the end opening 501 for discharge. On occasions the paper strips S may clog the interior of the shell 520, thereby jamming up the entire paper shredder 10. To facilitate the movement or flow of the paper strips S, the helical blade 512 may include agitating means adapted to agitate the paper strips S. Such agitating means is provided or constituted by the blade 512 having an edge or edge portion, e.g. its entire helical edge E, of a wavy shape or profile (FIG. 17). Such a wavy edge E presents, on its opposite sides, protrusions to agitate and nudge the paper strips S as the rotating member 511 rotates, thereby knocking loose any jammed paper strips S.

The exit device 500 is detachable from, and re-attachable to, the exit 220 of the paper shredder 10. The shell 520 of the exit device 500 includes, on the left and right sides of its open top side 523, two pairs of outwardly-facing side lugs 524. The housing 100 of the paper shredder 10 includes, on the left and right sides of its exit 220, two pairs of inwardly-facing side hooks 104. The side lugs 524 and side hooks 104 are matching for inter-engagement when the shell 520 is pressed up against the exit 220 and slid rearward towards the mount's extension 112, thereby slotting the side lugs 524 into the respective side hooks 104 for locking the exit device 500 attached to the housing 100 (FIG. 5). The exit device 500 may be detached from the exit 220 through reversed operation for, if necessary, emptying the exit device 500.

Upon said rearward sliding of the shell 520 and hence the whole exit device 500 towards the mount's extension 112, the shaft 512 of the rotating member 511 inside will be plugged with its rear end 512A into the driving socket 421 in the extension 112, whereby the shaft 512 becomes drivingly engaged with the motor 400 for rotation by the motor 400 via the gearbox 410, the gear train 420 and the socket 421. Thus, the moving mechanism 510 (i.e. rotating member 511) is driven by the same motor 400 as the shredding mechanism 300.

The paper shredder 10 is preferably a compact paper shredder and one that is operated by the AC mains. The shredding mechanism 300 is the major load for electrical power. Power rating and/or size can be curbed by shortening the shredding mechanism 300 and in particular by reducing the number of the shredding units 303. In this particular embodiment, the shredding length is designed to be about (i.e. slight over) half of the width of standard A4 size paper, i.e. 105 mm (210 mm×½). The length is chosen such that one or several sheets of A4 size paper can be shredded (without folding) in two operations, i.e. one lateral side first and then the other lateral side.

To offer such a partial shredding function, the entrance 210 and exit 220 comprise respective slots 210 and 220 each having an open end 210A/220A on an outer lateral side of the paper feeding path X, such that paper P wider than the paper feeding path X may in part be fed through the paper shredder 10 for shredding only that part of the paper P′. Such open-ended entrance and exit slots 210 and 220 are formed by the forward-pointing main part of the shredder housing 100 having a bifurcate configuration.

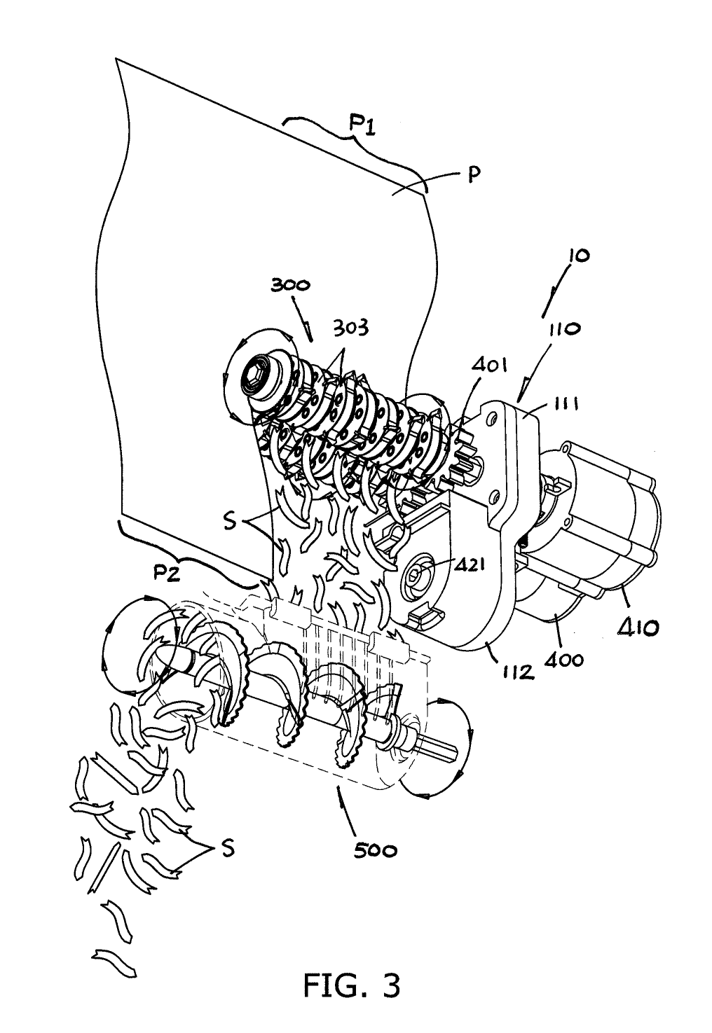

As illustrated in FIG. 3, right side P1 of the paper P is shredded in a first shredding operation (as shown) and then left side P2 in a subsequent shredding operation. During the first shredding operation, the un-shredded part P2 of the paper P will be obstructed by the free end of the exit device 500, as the exit device 500 is longer than the effective shredding length of the shredding mechanism 300, for example, to protect the entire shredding mechanism 300 from accidental access by a user.

This drawback is solved by providing a deflector 526 or deflecting surface 527 at or along a section 220B of the exit slot 220, by which the exit device 500 or its shell 520 extends beyond (i.e. longer than) the effective shredding length of the shredding mechanism 300. The deflector 526 provides the deflecting surface 527, both of which deflect by being inclined to one side of the exit device 500.

The deflector 526, including the deflecting surface 527, is provided by the exit device 500, as an upwardly wedge-like part thereof. The deflector 526 or its deflecting surface 527 defines one side of the paper feeding path X over the section 220B. The section 220B, along which the deflector 526 is located when the exit device 500 is attached for operation, are positioned beyond the shredding mechanism 300 on the outer lateral side of the paper feeding path X, such that the un-shredded left side P2 of the paper P is deflected to go past the exit device 500, without being obstructed by the exit device 500 while the paper's right side P1 is being shredded (FIG. 3). The right side P1 is subsequently shredded alone to complete the task.

The invention has been given by way of example only, and various other modifications of and/or alterations to the described embodiment may be made by persons skilled in the art without departing from the scope of the invention as specified in the appended claims.

1. A paper shredder comprising:
a housing having an entrance and an exit for paper to be shredded, wherein the entrance and exit are both oblong;
an electric motor in the housing;
a shredding mechanism driven by the electric motor and in the housing in a paper feeding path from the entrance to the exit for cutting the paper entering the housing, via the entrance, into smaller paper pieces which exit via the exit;
an exit device attached to the exit for arranging exit of the paper pieces, wherein
the exit has a length and the exit device extending along the length of the exit for collecting the paper pieces, and
the exit device has an opening for exit of the paper pieces, and a moving mechanism for moving the paper pieces to the opening for exit.

2. The paper shredder as claimed in claim 1, wherein
the shredding mechanism comprises first and second rows of shredding units mounted for rotation in opposite directions about respective parallel axes, and
the shredding units of the first row overlap the shredding units of the second row in an interlaced manner.

3. The paper shredder as claimed in claim 1, wherein the moving mechanism comprises a flow-creating device adapted to create a flow of the paper pieces to the opening.

4. The paper shredder as claimed in claim 3, wherein the flow-creating device comprises at least one rotating member for creating the flow.

5. The paper shredder as claimed in claim 4, wherein the at least one rotating member extends along at least part of the length of the exit for contact with the paper pieces to move the paper pieces to the opening.

6. The paper shredder as claimed in claim 5, wherein the at least one rotating member has a helical configuration.

7. The paper shredder as claimed in claim 5, wherein the at least one rotating member comprises a helical blade.

8. The paper shredder as claimed in claim 7, wherein the helical blade extends for a plurality of turns around and along a central axis of the flow-creating device.

9. The paper shredder as claimed in claim 8, wherein
the flow-creating device includes a shaft along the central axis, and
the helical blade comprises a series of blade sections arranged on and along the shaft to form the helical blade.

10. The paper shredder as claimed in claim 9, wherein
the shaft has an outer cross-section,
each of the blade sections has a central hole having an inner cross-section, and
the outer cross-section and inner cross-section have complementary non-circular shapes for angular inter-engagement such that the blade sections are rotatable with the shaft as a one-piece member.

11. The paper shredder as claimed in claim 9, wherein each blade section extends through an angle of less than 360° around the shaft.

12. The paper shredder as claimed in claim 11, wherein each blade section extends through an angle of about 270° around the shaft.

13. The paper shredder as claimed in claim 7, wherein the helical blade includes agitating means adapted to agitate the paper pieces, thereby facilitating movement of the paper pieces.

14. The paper shredder as claimed in claim 13, wherein the helical blade has an edge with a wavy shape or profile, which constitutes the agitating means.

15. The paper shredder as claimed in claim 7, wherein the at least one rotating member comprises a metering screw including the helical blade that extends helically along the metering screw.

16. The paper shredder as claimed in claim 1, wherein the opening is at an end of the exit device.

17. The paper shredder as claimed in claim 16, wherein
the exit device includes an oblong casing having first and second opposite ends,
the first end is open to provide the opening, and
the moving mechanism is driven at the second end of the oblong casing.

18. The paper shredder as claimed in claim 1, wherein the moving mechanism of the exit device is driven by the electric motor.

19. The paper shredder as claimed in claim 1, wherein the exit device is detachable from and re-attachable to the exit.

20. The paper shredder as claimed in claim 19, including a control circuit to control supply of electrical power to the electric motor, wherein the control circuit includes a detector for detecting the exit device upon attachment of the exit device to the exit, thereby enabling operation of the control circuit.

21. The paper shredder as claimed in claim 20, wherein the detector comprises a normally-open electrical switch arranged to be closed upon attachment of the exit device to the exit.

22. The paper shredder as claimed in claim 1, wherein
the entrance and exit comprise respective slots,
each slot has an open end on an outer lateral side of the paper feeding path, such that paper wider than the paper feeding path may, in part, be fed through the paper shredder for shredding only that part of the paper.

23. The paper shredder as claimed in claim 22, wherein
the housing has a forward-pointing main part which has a bifurcate configuration to form the slots, and
each slot has an open end, of the entrance and exit.

24. The paper shredder as claimed in claim 22, wherein
a section of the slot of the exit includes a deflector or deflecting surface to one side of the exit device, and
the section is positioned beyond the shredding mechanism on the outer lateral side of the paper feeding path, such that an un-shredded part of the paper is deflected to go past the exit device.

25. The paper shredder as claimed in claim 24, wherein the exit device includes the deflector or deflecting surface that defines one side of the paper feeding path over the section.
